(19) United States
(12) Patent Application Publication
(10) Pub. No.: US 2026/0128794 A1
(43) Pub. Date: May 7, 2026

(54) OPTICAL TRANSMISSION DEVICE AND OPTICAL TRANSMISSION SYSTEM

(71) Applicant: Fujitsu Limited, Kawasaki-shi (JP)

(72) Inventors: TOMOHIRO NAGANUMA, Kawasaki (JP); Naoya OKADA, Yokohama (JP); Joji TERASHI, Fukuoka (JP)

(73) Assignee: Fujitsu Limited, Kawasaki-shi (JP)

(21) Appl. No.: 19/379,130

(22) Filed: Nov. 4, 2025

(30) Foreign Application Priority Data
Nov. 5, 2024 (JP) 2024-193774

(51) Int. Cl. H04B 10/294; H04B 10/079; H04B 10/299; H04B 10/40

(52) U.S. Cl. CPC H04B 10/2941; H04B 10/0795; H04B 10/299; H04B 10/40

(57) ABSTRACT

An optical transmission device is configured to receive and process an optical signal received via an optical transmission line, the optical transmission device including: an output unit configured to output information concerning deviation of an amplitude characteristic of the received optical signal; a tunable optical filter (TOF) configured to filter the received optical signal; a controller configured to control a setting of the TOF based on the information concerning the deviation of the amplitude characteristic.

### CROSS REFERENCE TO RELATED APPLICATIONS

This application is based upon and claims the benefit of priority of the prior Japanese Patent Application No. 2024-193774, filed on Nov. 5, 2024, the entire contents of which are incorporated herein by reference.

### FIELD

The embodiments discussed herein are related to an optical transmission device and an optical transmission system.

### BACKGROUND

Optical amplifiers are used in recent optical transmission systems. An optical amplifier is provided, for example, in a reconfigurable optical add/drop multiplexer (ROADM) or the like on a transmission path, or is provided in an optical transceiver to amplify transmission/reception optical power. By using an optical amplifier, the number of electrical repeaters that are conventionally used may be reduced, whereby reductions in the cost and power of the system may be realized.

One method for realizing increases in the capacity of an optical communication system is to increase the capacity per wave of an optical signal. The transmission capacity per wave is related to the baud rate of the optical signal. By increasing the baud rate, the transmission capacity may be increased without changing the reception sensitivity. On the other hand, problems arise such as stricter requirements for the band characteristics of the transmitting and receiving devices and increased in power consumption of the optical transmission device.

One prior art involves adjusting an optical channel spectrum by varying the frequency of an optical filter based on the bit error rate (BER) to reduce the influence of asymmetric filtering. In addition, there is a technique for correcting variations in characteristics of a balanced receiver by controlling the amplitude and delay of an optical signal. In addition, there is a technique in which distortion is reduced by a compensation signal obtained by using a filtering operation to thereby extract a pilot tone included in a received signal. Another technique mitigates the effects of frequency dependent imbalances between the IQ subchannels of receiver channels and recovers data based on pre-stored calibration data. In addition, there is a technology in which a loss difference of an optical signal for each wavelength generated in a wavelength multiplexed signal is compensated by a loss compensator. For example, refer to Published Japanese-Translation of PCT Application, Publication No. 2022-519282, Japanese Laid-Open Patent Publication No. 2008-219765, U.S. Patent Application Publication No. 2014/0286642, U.S. Patent Application Publication No. 2012/0057863, and Japanese Laid-Open Patent Publication No. H11-275020.

### SUMMARY

According to an aspect of an embodiment, an optical transmission device is configured to receive and process an optical signal received via an optical transmission line, the optical transmission device including: an output unit configured to output information concerning deviation of an amplitude characteristic of the received optical signal; a tunable optical filter (TOF) configured to filter the received optical signal; a controller configured to control a setting of the TOF based on the information concerning the deviation of the amplitude characteristic.

An object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram depicting an optical transmission device according to a first embodiment.

FIG. 2 is a graph depicting an example of amplification characteristics of an optical amplifier.

FIG. 3A is an explanatory diagram of deviation of amplitude characteristics for each baud rate.

FIG. 3B is an explanatory diagram of deviation of amplitude characteristics for each baud rate.

FIG. 4 is a diagram depicting an example of internal functions of a DSP according to the first embodiment.

FIG. 5 is an explanatory diagram of control of tilt in signal band by changing a center frequency of a TOF.

FIG. 6 is a graph depicting an example of frequency characteristics of a compensation coefficient of an adaptive equalization circuit.

FIG. 7A is an explanatory diagram of an example of calculating tilt in the signal band from a tap number.

FIG. 7B is an explanatory diagram of an example of calculating tilt in the signal band from a tap number.

FIG. 8 is a flowchart depicting a control example of the optical transmission device according to the first embodiment.

FIG. 9 is a table depicting a setting example of whether to perform control for a signal type.

FIG. 10 is a diagram depicting an optical transmission system according to a second embodiment.

### DESCRIPTION OF EMBODIMENTS

First, problems associated with the conventional techniques are discussed. For example, as the baud rate of the optical signal increases, the width of the signal band of the optical signal increases. As a general property, an optical amplifier has a different amplification factor depending on the light wavelength. When an optical signal having a wide signal band passes through the optical amplifier, the amplification factor changes within the signal band. When deviation of an amplitude characteristic (amplification factor) in the signal band (referred to as tilt in the signal band) increases due to the increase in the baud rate, distortion of the signal spectrum occurs and degradation of characteristics of the received signal may occur. In order to realize a high baud rate, it is necessary to reduce tilt in the signal band and suppress increases in the distortion of the signal spectrum.

Here, embodiments of an optical transmission device and an optical transmission system according to the present disclosure are described in detail with reference to the accompanying drawings. The optical transmission device according to the embodiment is applied to, for example, an optical transceiver or an optical receiver. The optical receiver receives a digital coherent optical signal and changes the setting of the optical filter based on the deviation of the amplitude level in the signal band (tilt in the signal band), thereby reducing the tilt in the signal band.

In the optical communication transmission according to the embodiment, for example, an optical signal of quadrature amplitude modulation (QAM) is transmitted.

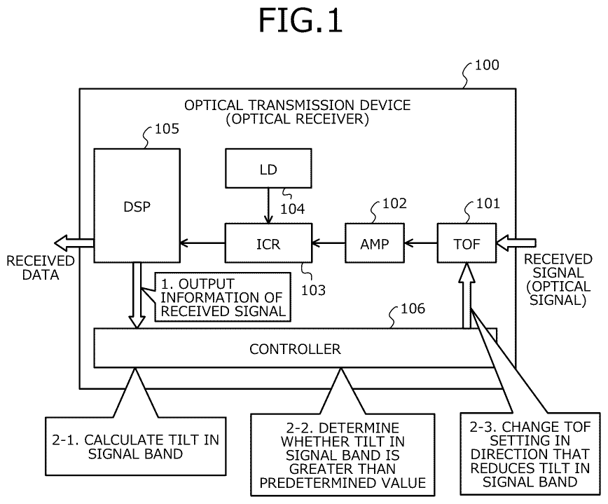

FIG. 1 is a diagram depicting an optical transmission device according to a first embodiment. The optical transmission device depicted in FIG. 1 is an optical receiver 100. The optical receiver 100 receives an optical signal transmitted by an optical transmitter via an optical transmission path. The optical receiver 100 includes a tunable optical filter (TOF) 101 as an optical filter, an optical amplifier 102, an integrated coherent receiver (ICR) 103, a laser diode (LD) 104, a digital signal processor (DSP) 105, and a controller 106.

The TOF 101 filters an optical signal received via an optical transmission line and outputs the filtered optical signal to the optical amplifier 102. The TOF 101 is, for example, a band-pass filter and has a band-pass characteristic of transmitting only a predetermined signal band. In the TOF 101, a center frequency f0 of the bandpass characteristic is variable. For example, the TOF 101 changes the center frequency f0 by varying a control voltage (voltage value) Vf output by the controller 106.

The AMP 102, which is an optical amplifier, optically amplifies the optical signal after the optical signal passes through the TOF 101. As the AMP 102, for example, an erbium doped fiber amplifier (EDFA), a fiber Raman amplifier (FRA), a semiconductor optical amplifier (SOA), or the like is used.

The ICR 103 performs reception processing such as optical detection of the received coherent light, optical signal-electrical signal conversion, optical attenuation, and polarization separation based on laser light (local light) of the LD 104. The DSP 105 performs processing such as analog-to-digital conversion and signal compensation on the received signal, and outputs the data. Further, the DSP 105 outputs information concerning the received signal (information concerning the deviation of the amplitude characteristic after the optical amplification by the AMP 102) to the controller 106. The DSP 105 has a function as an output unit that outputs information concerning the deviation of the amplitude characteristic.

The controller 106 determines the tilt in the signal band of the reception signal based on the output of the DSP 105 (information concerning the deviation of the amplitude characteristic), and controls the TOF 101 so as to reduce the tilt in the signal band. In the configuration example depicted in FIG. 1, the controller 106 changes the center frequency f0 by variably controlling the control voltage Vf of the TOF 101, based on the information concerning the deviation of the amplitude characteristic.

The optical receiver 100 of the first embodiment performs the following processing based on the control of the controller 106 at the time of the reception processing of the reception signal.

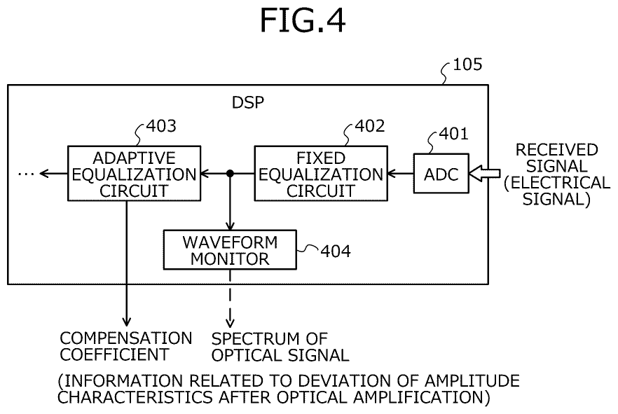

1. The DSP 105 transfers (outputs) information concerning the received signal (information concerning the deviation of the amplitude characteristic) to the controller 106. The information concerning the deviation of the amplitude characteristic is, for example, a compensation coefficient of an adaptive equalization circuit (see FIG. 4).

2. The controller 106 controls the setting of the TOF 101 based on the information of the received signal (information concerning the deviation of the amplitude characteristic).

2-1. First, the controller 106 calculates the tilt in the signal band of the reception signal, based on the information of the reception signal (information regarding the deviation of the amplitude characteristic).

2-2. Under the control of the controller 106, the setting of the TOF 101 is changed in a direction in which the tilt in the signal band is reduced. More specifically, for example, the controller 106 determines whether the value (absolute value) of the tilt in the signal band is greater than a predetermined value (for example, a threshold value).

2-3. When the absolute value of the tilt in the signal band is greater than a predetermined value (threshold value), the controller 106 changes the setting of the TOF 101 provided in the optical receiver 100 in a direction in which the absolute value of the tilt in the signal band decreases. The “setting” of the TOF 101 is, for example, the center frequency f0 of the TOF 101. The “predetermined value (threshold value)” and the settable range of the TOF 101 may be set to arbitrary values.

3. The controller 106 continues to periodically perform the above-described processing during the operation of the apparatus.

Here, the technical background and problems thereof are described.

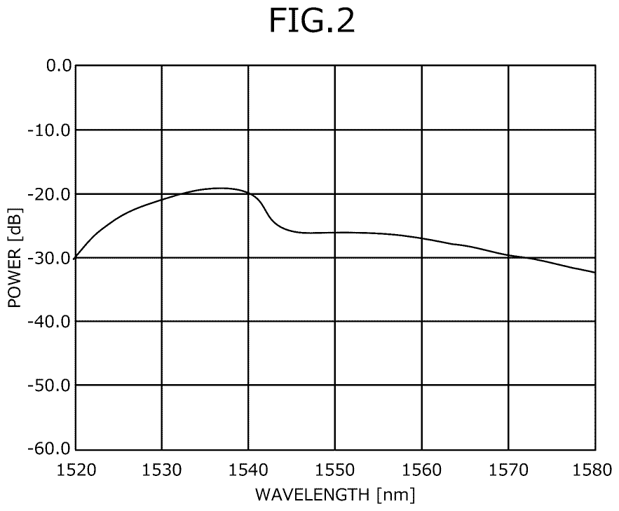

FIG. 2 is a graph depicting an example of amplification characteristics of an optical amplifier. The horizontal axis represents the wavelength (Wavelength [nm]) and the vertical axis represents the optical power (Power [dB]), depicting the wavelength dependence of the EDFA.

As depicted in FIG. 2, the optical power due to optical amplification with respect to the wavelength differs. For example, the optical power with respect to the wavelength is not flat but wavy, and the optical power for each wavelength is different.

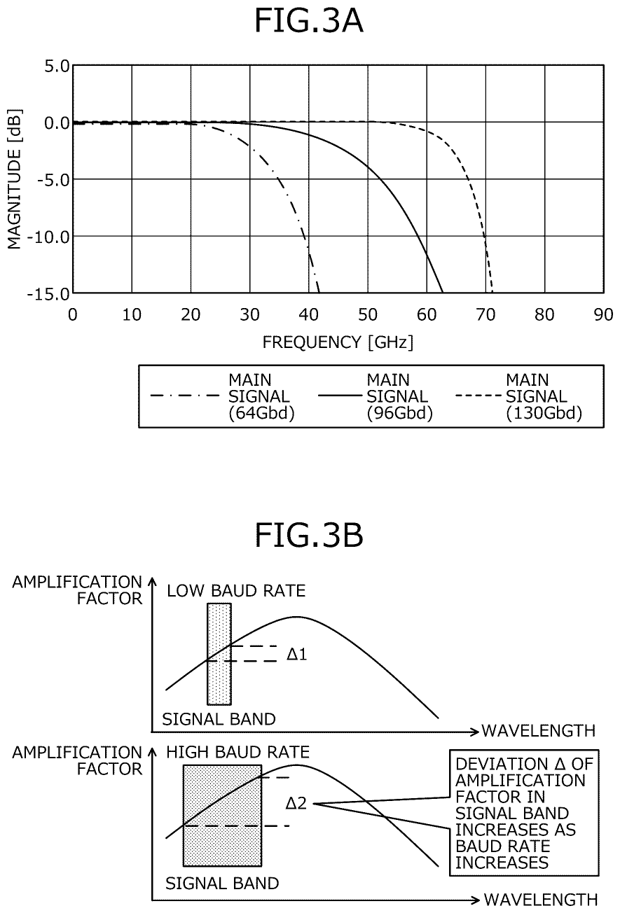

FIGS. 3A and 3B are explanatory diagrams of deviation of amplitude characteristics for each baud rate. FIG. 3A depicts a frequency spectrum of a received signal (main signal) for each baud rate. A horizontal axis represents frequency ([GHz]), and the vertical axis represents optical energy (magnitude [dB]). As the baud rate increases to 64 Gbd, 96 Gbd, and 130 Gbd, the bandwidth (flat characteristic portion) of the signal increases in the frequency direction.

FIG. 3B depicts deviation of the amplitude characteristic after optical amplification for each baud rate. A horizontal axis represents the wavelength, and a vertical axis represents the amplification factor of the optical amplifier. At a low baud rate, the width of the signal band to be amplified by the optical amplifier is narrow, whereas at a high baud rate, the width of the signal band to be amplified by the optical amplifier is wide. At a low baud rate, the deviation of the amplitude characteristic after the optical amplification is only Δ1, whereas at a high baud rate, the deviation of the amplitude characteristic after the optical amplification is Δ2, and the deviation Δ of the amplification factor in the signal band increases as the baud rate increases. Thus, when a signal having a high baud rate and a wide bandwidth passes through the optical amplifier as depicted in FIG. 3B, deviation (tilt in signal band) occurs in the optical amplification factor (amplitude characteristic) in the signal band.

The deviation of the amplitude characteristic within the signal band (tilt within the signal band) leads to an occurrence of distortion of the signal spectrum, resulting in deterioration of the characteristic of the received signal.

In order to eliminate the tilt in the signal band, for example, while it is conceivable to reduce the wavelength dependency of the amplification factor by providing an optical equalizer, this may be a factor contributing to an increase in cost.

On the other hand, in the first embodiment, the tilt in the signal band is calculated, and the tilt in the signal band is reduced by the TOF based on the tilt in the signal band, so that the tilt in the signal band may be reduced even when the width of the signal band of the optical signal is increased due to an increase in the baud rate.

FIG. 4 is a diagram depicting an example of internal functions of the DSP according to the first embodiment. The DSP 105 includes an AD converter (ADC) 401, a fixed equalization circuit 402, and an adaptive equalization circuit 403. The ADC 401 performs digital-analog conversion on the input reception signal (electrical signal). The fixed equalization circuit 402 compensates for the chromatic dispersion of the optical transmission line. The adaptive equalization circuit 403 adaptively equalizes the output signal of the fixed equalization circuit 402. For example, the adaptive equalization circuit 403 performs frequency offset compensation, polarization mode dispersion compensation, carrier phase recovery, and the like.

The information concerning the deviation of the amplitude characteristic described above is, for example, a compensation coefficient output by the adaptive equalization circuit 403. The DSP 105 may include a waveform monitor 404 that monitors the waveform of the reception signal output from the fixed equalization circuit 402. The spectral shape of the optical signal output from the waveform monitor 404 may be used as the information concerning the deviation of the amplitude characteristic. The controller 106 receives the information concerning the deviation of the amplitude characteristic output from the DSP 105.

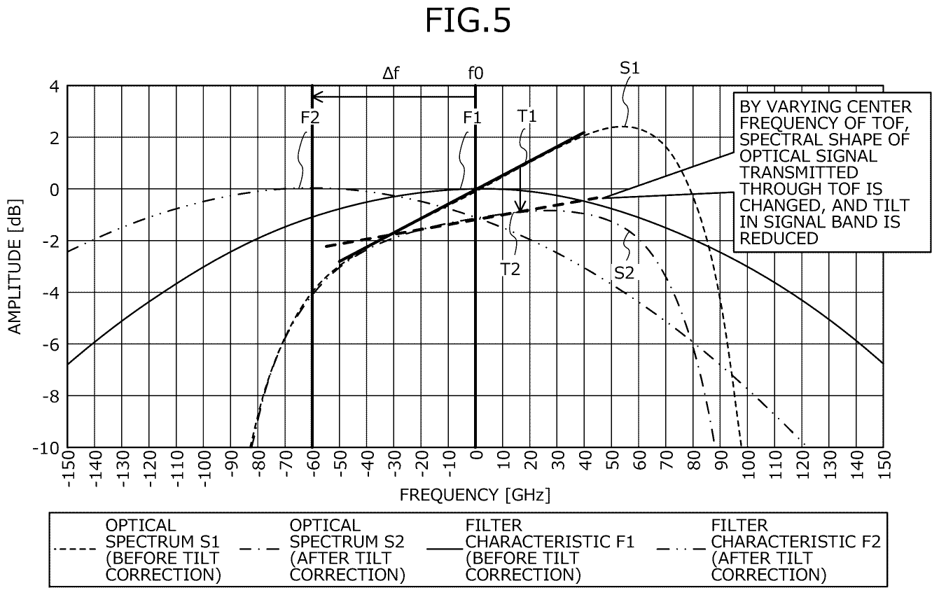

FIG. 5 is an explanatory diagram of control of the tilt in the signal band by changing the center frequency of the TOF. In FIG. 5, a horizontal axis represents the frequency [GHz], and a vertical axis represents the amplitude [dB] of the reception signal output by the TOF 101. The inventors have found that the tilt in the signal band may be controlled by changing the center frequency f0 of the TOF 101.

When a filter characteristic is F1 (center frequency f0=0 GHz), the optical spectrum output by the TOF 101 is S1. A TOF filter characteristic F2 (when the center frequency f0=−60 GHz, the optical spectrum output by the TOF 101 is S2. Thus, it has been found that the spectral shape of the optical signal transmitted through the TOF 101 changes by changing the center frequency f0 of the TOF 101.

When the filter characteristic is F1 (center frequency f0=0 GHz), the optical spectrum S1 output by the TOF 101 has a tilt T1 in the signal band (before tilt correction). On the other hand, by changing the center frequency f0 of the TOF 101 to Δf0 (−60 GHz), the spectrum shape of the optical spectrum S2 output by the TOF 101 is shaped so as to have an inclination of the tilt T2 in the signal band, and the inclination becomes gentler than the tilt T1 in the signal band (after tilt correction). As described above, by changing the center frequency f0 of the TOF 101, the spectral shape of the optical signal transmitted through the TOF 101 is changed, and the tilt in the signal band may be reduced.

After the tilt correction depicted in FIG. 5, the center frequency of the signal band indicated by the optical spectrum S2 and the center frequency f0 of the filter characteristic F2 of the TOF 101 differ from each other by Δf0.

The controller 106 calculates the tilt in the signal band of the reception signal based on the information (for example, the compensation signal) regarding the deviation of the amplitude characteristic output from the DSP 105. Then, the controller 106 changes the center frequency f0 of the TOF 101 by variably controlling the control voltage Vf of the TOF 101 so as to reduce the calculated tilt in the signal band.

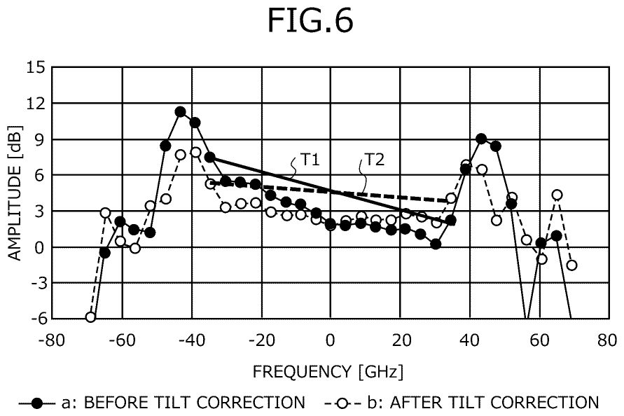

FIG. 6 is a graph depicting an example of frequency characteristics of a compensation coefficient of the adaptive equalization circuit. A horizontal axis represents the frequency [GHz], and a vertical axis represents the amplitude [dB] of the received signal. The adaptive equalization circuit 403 dynamically generates a compensation coefficient based on the state of the received signal at the current time. The controller 106 calculates the tilt in the signal band of the reception signal based on the compensation coefficient.

FIG. 6 depicts a frequency characteristic a of the adaptive equalization circuit coefficient before the tilt correction and a frequency characteristic b of the adaptive equalization circuit coefficient after the tilt correction. By changing the center frequency of the optical filter, the spectral shape of the transmitted optical signal is changed, and the tilt in the signal band is reduced from T1 to T2.

Here a procedure for calculating the tilt in the signal band from the compensation coefficient by the controller 106 is described. 1. The compensation coefficients expressed by a time domain are transformed to a frequency domain using Fourier transform. 2a. A difference of two arbitrary points in the converted frequency domain characteristics (hereinafter referred to as frequency characteristics) is defined as the tilt in the signal band.

For example, when the compensation coefficient is a finite impulse response (FIR) filter having an arbitrary tap number i, the compensation coefficient is represented as [x1, x2, x3, . . . , xi]. For example, the FIR filter is provided in the adaptive equalization circuit 403. The controller 106 sets the frequency characteristic obtained by converting the compensation coefficient using Fourier transform to [y1, y2, y3, . . . , yi]. In the frequency characteristic, a difference of two arbitrary points, for example, y2 and y6 is defined as the tilt in the signal band.

2b. In addition, the controller 106 may determine a difference of an average value in an arbitrary range in the frequency characteristic and an average value in an arbitrary range different from the above range as the tilt in the signal band. For example, a difference of [an average value of y2, y3, and y4] of the frequency characteristics and an average value in an arbitrary range different from the above, for example, [an average value of y6, y7, and y8] may be determined as the tilt in the signal band.

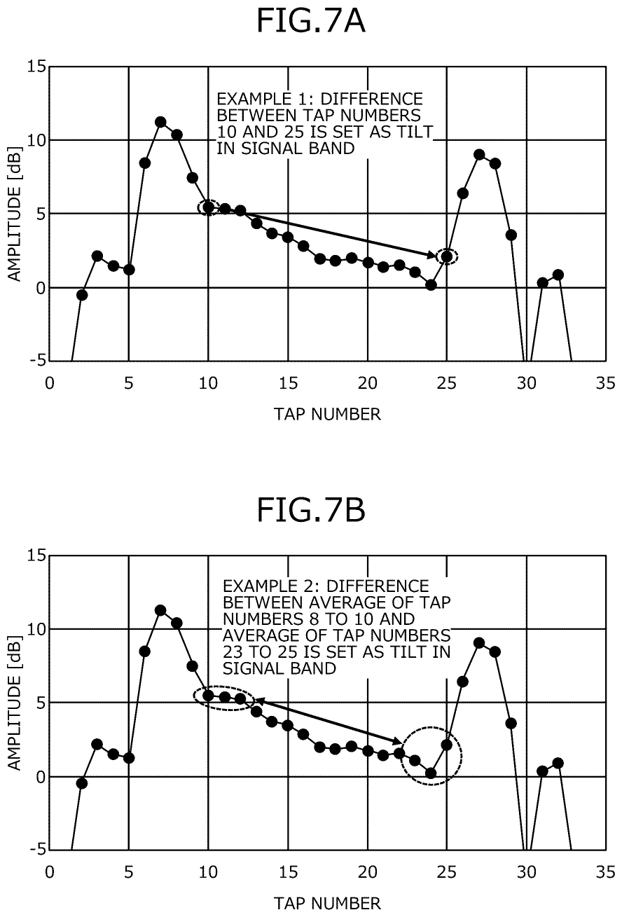

FIGS. 7A and 7B are explanatory diagrams of an example of calculating the tilt in the signal band from a tap number. In example 1 depicted in FIG. 7A, a difference of tap numbers 10 and 25 of two arbitrary points of the FIR is set as the tilt in the signal band. In example 2 depicted in FIG. 7B, the difference of the average of the tap numbers 8 to 10 of the FIR and the average of the tap numbers 23 to 25 is set as the tilt in the signal band.

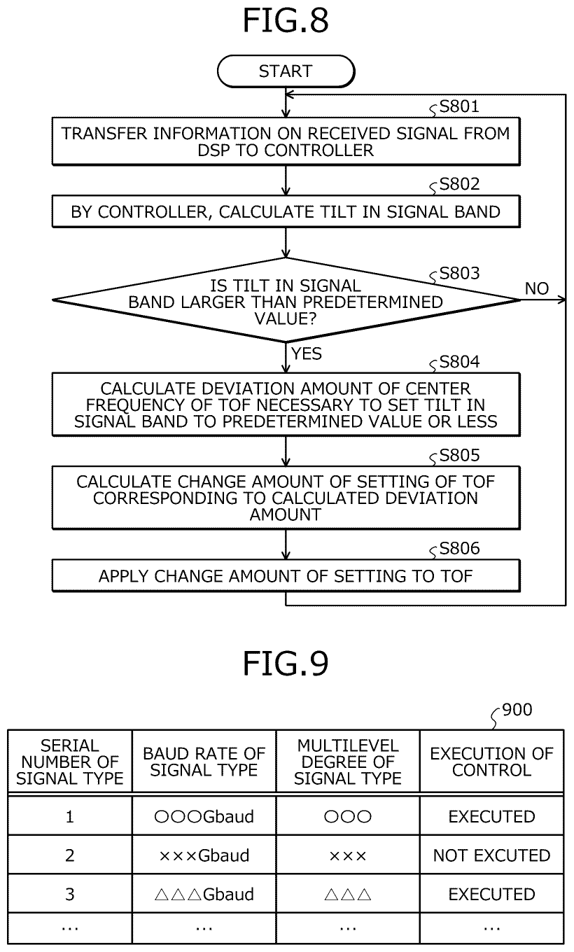

FIG. 8 is a flowchart depicting a control example of the optical transmission device according to the first embodiment. First, information concerning the received signal (information concerning the deviation of the amplitude characteristic) is transferred from the DSP 105 to the controller 106 (step S801).

Next, the controller 106 calculates tilt in the signal band (step S802). Next, the controller 106 determines whether the tilt in the signal band is greater than a predetermined value (threshold value) (step S803). When the tilt in the signal band is smaller than the predetermined value (NO in step S803), the controller 106 returns to the process at step S801. On the other hand, when the tilt in the signal band is greater than (equal to or greater than) the predetermined value (threshold value) (step S803: YES), the controller 106 proceeds to the process at step S804.

At step S804, the controller 106 calculates a deviation amount of the center frequency f0 of the TOF 101 necessary to set the tilt in the signal band to a predetermined value or less (step S804). Then, the controller 106 calculates a change amount of the setting of the TOF 101 corresponding to the calculated deviation amount (step S805). For example, the change amount of the setting is a change amount of the center frequency f0 of the TOF 101 (for example, refer to FIG. 5).

Then, the controller 106 applies the change amount of the setting to the TOF 101 (step S806), and returns to the process at step S801. As described, the optical receiver 100 continues to periodically perform the processing depicted in FIG. 8 during the operation of the device.

The process at step S803 to step S806 are described in more detail. The controller 106 determines whether the absolute value of the tilt in the signal band is greater than a predetermined value. Here, when the absolute value of the tilt in the signal band is greater than the predetermined value, the controller 106 calculates the amount of shift of the center frequency of the optical filter necessary for setting the calculated absolute value of the tilt in the signal band to the predetermined value. For example, how many GHz of the center frequency f0 are to be shifted with respect to the tilt of 1 dB in the signal band is set in advance as a set value of the shift amount.

Based on the set value of the shift amount, the controller 106 calculates how many GHz the shift amount is to be with respect to the tilt in the signal band calculated for the current reception signal. Then, the controller 106 calculates an amount of change of the setting of the TOF 101 corresponding to the calculated deviation amount. The “setting” is the control voltage (voltage value) Vf applied to the TOF 101, and the controller 106 calculates (converts) the amount of change in the voltage value corresponding to the amount of deviation from the correspondence relationship between the center frequency f0 and the voltage value Vf determined as the product characteristics of the TOF 101. Then, the controller 106 applies the calculated change amount of the setting (the calculated voltage value Vf) to the TOF 101.

The optical receiver 100 described in the first embodiment may receive, for example, multiple signal types having different baud rates corresponding to the improvement of the baud rate. In this case, it is assumed that implementation of the present disclosure has little significance depending on the type of received signal. Therefore, whether to perform the control according to the embodiment described in FIG. 8 and the like may be set in the optical receiver 100 for each signal type to be received. The signal type of the received signal is classified according to the combination of the parameters of the baud rate and the multilevel degree. For this reason, whether to perform the control on each signal type for each combination of the baud rate and the multilevel degree is determined.

FIG. 9 is a table depicting a setting example of whether to perform control for a signal type. The control execution setting value 900 includes items: a serial number of a signal type, a baud rate of the signal type, a multilevel degree of the signal type, and execution/non-execution of control. In FIG. 9, a baud rate and a multilevel degree are set as parameters constituting a signal type.

In the example of the setting value 900 in FIG. 9, when the received signal is the signal type 1 (baud rate OOO G baud, multilevel degree OOO), the controller 106 “implements”the control described in the first embodiment. When the received signal is of the signal type 2 (baud rate xxx G baud, multilevel degree xxx), the controller 106 “does not perform” the control described in the first embodiment, that is, does not perform the control. As described, it is possible to select whether to perform the control described in the first embodiment depending on at least one parameter of the baud rate and the multilevel degree of the received signal type, and the control described in the first embodiment may be applied only to a suitable signal type.

An example of application to an optical transmission system is described. The optical transmission system includes a first optical transmission device (optical transmitter) that transmits a transmission signal (optical signal) onto a transmission path, and a second optical transmission device (optical receiver) that receives a reception signal (optical signal) via the transmission path. The optical receiver described in the first embodiment may be applied to the optical receiver 100 of the optical transmission system. Thus, even when the baud rate of the optical signal transmitted in the optical transmission system increases, the tilt in the signal band may be reduced to improve the transmission performance. The tilt may occur not only when an optical amplifier is provided in the optical transmitter but also when an optical amplifier is provided in the middle of the optical transmission line. Even in this case, since the tilt in the signal band may be corrected, the tilt in the signal band may be reduced in the entire optical transmission system for optical transmission and reception.

In the first embodiment, an example in which the TOF 101 provided in the optical receiver 100 is controlled has been described. In a second embodiment, an example of controlling a TOF provided in an optical transmitter instead of controlling the TOF 101 provided in the optical receiver 100 will be described.

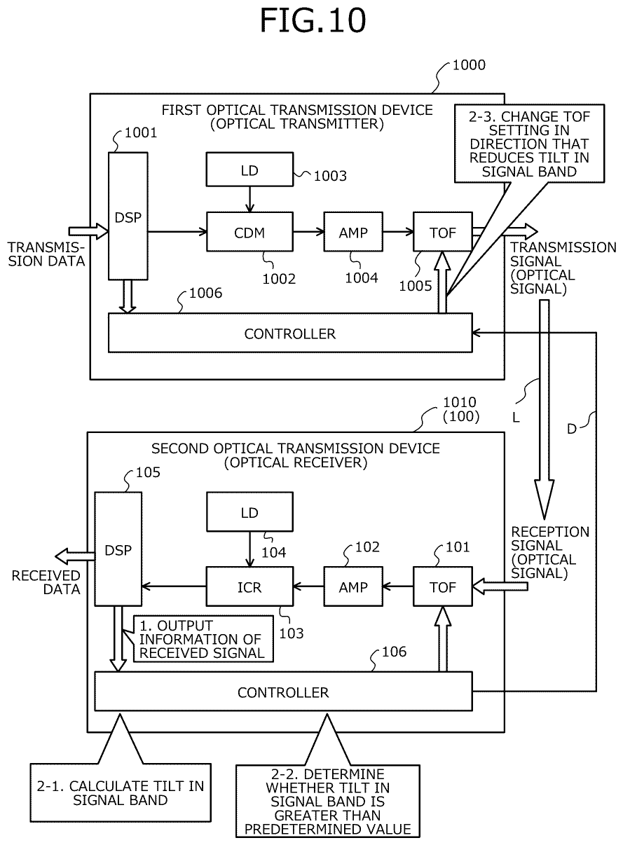

FIG. 10 is a diagram depicting an optical transmission system according to the second embodiment. In the optical transmission system, a first optical transmission device (optical transmitter) 1000 and a second optical transmission device (optical receiver) 1010 are connected via an optical transmission line L.

The optical transmitter 1000 includes a DSP 1001, a CDM (Coherent Driver Modulator) 1002, an LD 1003, an optical amplifier (AMP) 1004, a TOF 1005, and a controller 1006.

The DSP 1001 performs digital-analog conversion of transmission data; frame conversion; digital modulation processing by a modulation scheme and at a predetermined baud rate based on the setting of the controller 106; symbol mapping; compensation processing of band characteristics; and the like on transmission data.

The CDM 1002 converts transmission data into an optical signal based on laser light (local light) of the LD 1003, and includes an optical modulator and a driver. The AMP 1004 optically amplifies the optical signal that has passed through the CDM 1002. The optical signal output from the AMP 1004 is filtered, and the filtered optical signal is output to the optical transmission line L. The TOF 101 is a band-pass filter similar to the TOF 101 described in the first embodiment and has a band-pass characteristic of transmitting only a predetermined signal band. In the TOF 101, the center frequency f0 of the bandpass characteristic is variable. For example, the TOF 1005 changes the center frequency f0 by changing the control voltage (voltage value) Vf output by the controller 1006.

The optical receiver 1010 has the same configuration as that of the optical receiver 100 described in the first embodiment and is denoted by the same reference numerals used in the first embodiment.

In the optical transmission system according to the second embodiment, the optical receiver 1010 and the optical transmitter 1000 perform the following processing.

Processing on the optical receiver 1010 side is described. 1. The DSP 105 transfers (outputs) information concerning a reception signal (information concerning the deviation of the amplitude characteristic) to the controller 106. The information concerning the deviation of the amplitude characteristic is, for example, a compensation coefficient of the adaptive equalization circuit (see FIG. 4).

2. The controller 106 controls the setting of the TOF 101 based on the information of the reception signal (information concerning the deviation of the amplitude characteristic).

2-1. First, the controller 106 calculates the tilt in the signal band of the reception signal based on the information of the reception signal (information regarding the deviation of the amplitude characteristic).

2-2. Under the control of the controller 106, the setting of the TOF 101 is changed in a direction in which the tilt in the signal band is reduced. More specifically, for example, the controller 106 determines whether the value (absolute value) of the tilt in the signal band is greater than a predetermined value (for example, a threshold value). As a result of the determination, when the value (absolute value) of the tilt in the signal band is greater than a predetermined value (for example, a threshold value), the controller 106 transmits the setting change information D to the optical transmitter 1000.

Processing on optical transmitter 1000 side is described. 2-3. When the setting change information D is received (when the absolute value of the tilt in the signal band is greater than a predetermined value (threshold value)), the controller 1006 changes the setting of the TOF 1005 provided in the optical transmitter 1000 in a direction so that the absolute value of the tilt in the signal band decreases. The “setting” of the TOF 1005 is, for example, the center frequency f0 of the TOF 101.

3. The optical receiver 1010 (the controller 106) and the optical transmitter 1000 (the controller 1006) continue to periodically perform the above-described processing during the device operation.

The setting change information D may be transmitted from the optical receiver 1010 to the optical transmitter 1000 via a wired or wireless electrical or optical transmission system. For example, the setting change information D may be included in an optical service channel (OSC) on an optical transmission path from the optical receiver 1010 to the optical transmitter 1000 and transmitted.

The processing performed by the optical receiver 1010 and the processing performed by the optical transmitter 1000 may be appropriately changed. That is, the tilt in the signal band of the transmission signal transmitted by the optical transmitter 1000 may be changed and controlled based on the information (information concerning the deviation of the amplitude characteristic) of the reception signal received by the optical receiver 1010.

For example, the controller 106 on the optical receiver 1010 side may directly send “1. Information concerning the signal (information concerning the deviation of the amplitude characteristic) received by the DSP 105” to the optical transmitter 1000. In this case, on the side of the optical transmitter 1000, the following steps 2. (2-1. to 2-3.) may be performed.

According to the second embodiment described above, the TOF 1005 of the optical transmitter 1000 transmits the transmission signal in which the tilt in the signal band is reduced based on the reception signal on the optical receiver 1010 side, thereby reducing the tilt in the signal band in the entire optical transmission and reception. Further, even when an optical amplifier is not provided in the optical transmitter or the optical receiver, the tilt in the signal band may be reduced in the entire optical transmission system when an optical amplifier is provided along the optical transmission line.

As still another configuration example of the optical transmission system, the first embodiment may be combined with the second embodiment. More specifically, in the example depicted in FIG. 10, the TOF (first TOF) 1005 on the optical transmitter 1000 side and the TOF (second TOF) 101 on the optical receiver 1010 side each perform optical filtering, respectively. The controller (second controller) 106 on the optical receiver 1010 side controls the setting of the second TOF 101 based on the received information concerning the deviation of the amplitude characteristic. The controller (first controller) 1006 on the optical transmitter 1000 side controls the setting of the first TOF 1005 based on the information concerning the deviation of the amplitude characteristic received from the optical receiver 1010 (second controller 106). Accordingly, the TOF 1005 of the optical transmitter 1000 may transmit a transmission signal in which the tilt in the signal band is reduced, and the TOF 101 of the optical receiver 1010 may reduce the tilt in the signal band of the reception signal, so that the tilt in the signal band of the entire optical transmission system including the optical transmission path may be reduced. Further, even when the optical transmitter and the optical receiver do not include an optical amplifier, the tilt in the signal band may be reduced in the entire optical transmission system when the optical amplifier is provided in the middle of the optical transmission line.

Since the optical transmission device needs high-speed processing of signals, a dedicated DSP is currently used. The present disclosure is not limited to this, and an ASIC or an FPGA corresponding to high-speed processing may also be used. Further, as the controller, a CPU whose speed will be increased in the future may also be used. ASIC is an abbreviation for Application Specific Integrated Circuit, and FPGA is an abbreviation for Field Programmable Gate Array.

The optical receiver according to the embodiment described above performs reception processing on an optical reception signal received via an optical transmission path. The optical receiver includes an output unit (DSP) that outputs information concerning a deviation (tilt in a signal band) of an amplitude characteristic of the reception signal, a TOF that performs filtering of the reception signal, and a controller that controls setting of the TOF based on the tilt in the signal band. The information concerning the deviation of the amplitude characteristic is, for example, information concerning the deviation of the amplitude characteristic after the optical amplification by the optical amplifier. However, the optical receiver according to the embodiment may control the tilt in the signal band based on the information concerning the deviation of the amplitude characteristic even in the configuration free of the optical amplifier. Thus, the tilt in the signal band may be reduced. In addition, since it is possible to reduce the tilt in the signal band at the time of increasing the baud rate and suppress an increase in distortion of the signal spectrum without providing an optical equalizer or the like, it is possible to improve the transmission characteristics at low cost.

In the optical receiver according to the embodiment, the controller variably controls the center frequency of the TOF based on the tilt in the signal band. For example, the TOF has a bandpass optical filter characteristic. By changing the center frequency of the TOF, the spectrum optical signal transmitted by the TOF may be changed. For example, the center frequency of the TOF is set to a value different from the center frequency of the signal band of the reception signal. Accordingly, the tilt in the signal band may be easily reduced by merely changing the center frequency of the TOF.

In the optical receiver according to the embodiment, the controller calculates the tilt in the signal band using the output of the waveform monitor of the received signal or the compensation coefficient of the adaptive equalization circuit. As described, the tilt in the signal band may be easily calculated using information output by an existing function of the device.

In the optical receiver according to the embodiment, the controller compares the absolute value of the tilt in the signal band with a predetermined threshold, and controls the setting of the TOF in a direction so that the absolute value of the tilt in the signal band decreases, when the absolute value of the tilt in the signal band is greater than the threshold. This makes it possible to reduce the incline (incline direction with respect to the frequency) of the tilt in the signal band having a large inclination.

In the optical receiver according to the embodiment, the controller selects whether to change the TOF setting for a predetermined signal type including at least one parameter of the baud rate and the multilevel degree, which are parameters of multiple of signal types of the reception signal. This makes it possible to apply processing to a signal type that needs reduction of tilt in the signal band.

An optical transmission system according to an embodiment includes an optical transmitter that transmits an optical transmission signal to an optical transmission path, and an optical receiver that receives an optical reception signal via the optical transmission path. The optical transmitter transmits the transmission signal and controls the setting of the TOF in the optical receiver based on the tilt in the signal band by the above-described configuration. As described above, the optical transmission device may be applied to an optical transmission system that transmits and receives optical signals.

In the optical transmission system according to the embodiment, the optical receiver may transmit information concerning the tilt in the signal band, and the optical transmitter may control the setting of the TOF in the optical transmitter based on the tilt in the signal band.

Further, the optical receiver may control the setting of the TOF in the optical receiver based on the tilt in the signal band, and the optical transmitter may control the setting of the TOF in the optical transmitter based on the tilt in the signal band transmitted from the optical transmitter. Accordingly, the optical transmitter may transmit a transmission signal in which the tilt in the signal band is reduced, and the optical receiver may also reduce the tilt in the signal band from the reception signal.

According to one aspect of the present disclosure, an effect is achieved in that tilt in a signal band may be reduced.

All examples and conditional language provided herein are intended for pedagogical purposes of aiding the reader in understanding the disclosure and the concepts contributed by the inventor to further the art, and are not to be construed as limitations to such specifically recited examples and conditions, nor does the organization of such examples in the specification relate to a depicting of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. An optical transmission device configured to receive and process an optical signal received via an optical transmission line, the optical transmission device comprising:
an output unit configured to output information concerning deviation of an amplitude characteristic of the received optical signal;
a tunable optical filter (TOF) configured to filter the received optical signal;
a controller configured to control a setting of the TOF based on the information concerning the deviation of the amplitude characteristic.

2. The optical transmission device according to claim 1, wherein the controller variably controls a center frequency of the TOF, based on information concerning the deviation of the amplitude characteristic.

3. The optical transmission device according to claim 1, wherein the controller calculates the deviation of the amplitude characteristic using an output of a waveform monitor for the received optical signal or a compensation coefficient of an adaptive equalization circuit.

4. The optical transmission device according to claim 1, wherein the controller compares an absolute value of the deviation of the amplitude characteristic with a threshold value, and controls the setting of the TOF in a direction so that the absolute value of the deviation of the amplitude characteristic decreases, when the absolute value of the deviation of the amplitude characteristic is greater than the threshold value.

5. The optical transmission device according to claim 1, wherein the controller selects whether to change the setting of the TOF for a predetermined signal type that includes at least one of a baud rate and a multilevel degree which are parameters of a plurality of signal types of the received optical signal.

6. The optical transmission device according to claim 1, wherein the controller sets a center frequency of the TOF to a value different from a center frequency of a signal band of the received optical signal.

7. The optical transmission device according to claim 1, further comprising an optical amplifier configured to optically amplify the received optical signal, wherein
the information concerning the deviation of the amplitude characteristic is information concerning the deviation of the amplitude characteristic after optical amplification.

8. The optical transmission device according to claim 1, wherein the TOF has a bandpass optical filter characteristic.

9. An optical transmission system, comprising:
a first optical transmission device configured to transmit an optical transmission signal to an optical transmission line;
and a second optical transmission device configured to receive an optical reception signal via the optical transmission line, wherein
the first optical transmission device transmits the optical transmission signal, and
the second optical transmission device includes:
an output unit configured to output information concerning deviation of an amplitude characteristic of the optical reception signal;
a first tunable optical filter (TOF) configured to filter the optical reception signal;
a first controller configured to control setting of the first TOF based on the information concerning the deviation of the amplitude characteristic.

10. The optical transmission system according to claim 9, wherein
the output unit transmits the information concerning the deviation of the amplitude characteristic to the first optical transmission device, and
the first optical transmission device includes:
a second TOF configured to filter the optical transmission signal;
a second controller configured to control the setting of the second TOF based on the received information concerning the deviation of the amplitude characteristic.

11. An optical transmission system, comprising:
a first optical transmission device configured to transmit an optical transmission signal to an optical transmission line; and
a second optical transmission device configured to receive an optical reception signal via the optical transmission line, wherein
the first optical transmission device includes:
a TOF configured to filter the optical transmission signal;
a controller configured to control setting of the TOF based on information concerning a deviation of an amplitude characteristic, and
the second optical transmission device includes an output unit configured to output the information concerning the deviation of the amplitude characteristic to the first optical transmission device.
